(19) United States
(12) Patent Application Publication
(10) Pub. No.: US 2026/0086055 A1
(43) Pub. Date: Mar. 26, 2026

(54) APPARATUS FOR MEASURING WATER VAPOR IN ATMOSPHERE

(71) Applicant: The United States of America, as represented by the Secretary of Commerce, Silver Spring, MD (US)

(72) Inventor: Emrys Hall, Boulder, CO (US)

(21) Appl. No.: 19/333,768

(22) Filed: Sep. 19, 2025

Related U.S. Application Data
(60) Provisional application No. 63/696,877, filed on Sep. 20, 2024.

(51) Int. Cl. G01N 25/68; G01K 3/00; G01N 25/14; G01W 1/08

(52) U.S. Cl. CPC G01N 25/68; G01K 3/005; G01N 25/142; G01N 25/145; G01W 1/08

(57) ABSTRACT

Embodiments of the present invention provide a frost point hygrometer apparatus utilizing dry ice and ethanol, or liquid nitrogen, as cryogenic coolant. FPH apparatus in accordance with embodiments of the present invention includes a copper cold finger with a sink immersed in a liquid cryogen to provide cooling power throughout the profile, a polished mirror disk residing at the opposite end of the cold finger with ambient air passing over it, a nichrome heater wrapped around the narrow shaft of the continuous cold finger and mirror piece to provide heat to the mirror, an optical source and detector, including an infrared light-emitting diode and a photodiode, to monitor the mirror's reflectivity as condensate accumulates in the form of dew or frost, a biconvex lens to focus the light reflected from the mirror into the photodiode, and a calibrated thermistor embedded in the mirror to measure the frost point temperature.

### CROSS-REFERENCE TO RELATED APPLICATION

This application claims the benefit of priority from U.S. Provisional Patent Application Ser. No. 63/696,877, filed on Sep. 20, 2024, and entitled “Apparatus for Measuring Water Vapor in Atmosphere,” the disclosure of which is incorporated herein by reference in its entirety.

### STATEMENT REGARDING FEDERAL RIGHTS

The invention described herein was made with United States Government support from the National Oceanic and Atmospheric Administration (NOAA), an agency of the United States Department of Commerce. The United States Government has certain rights in the invention.

### FIELD OF THE INVENTION

The present invention relates generally to the measurement of water vapor in atmosphere, and more particularly, to an apparatus for the measurement of water vapor profiles in the upper troposphere and lower stratosphere.

### BACKGROUND OF THE INVENTION

Water vapor is the most abundant and important greenhouse gas in the atmosphere and contributes to many processes and feedback mechanisms. Although a majority of this highly variable invisible gas is found near the surface, water vapor in the upper troposphere and stratosphere can significantly influence climate. Accurate measurements of upper tropospheric and lower stratospheric water vapor are important for understanding changes in stratospheric water vapor and their impact on the radiative forcing of climate.

Stratospheric water vapor exists in relatively high concentration (>1 ppmv) compared to most trace gases in the atmosphere but is difficult to measure. A network of frost point hygrometers (FPHs) with global coverage are being used to capture monthly water vapor profiles from sites around the globe. Typical cryogens used for chilled mirrors in such network of FPHs include trifluoromethane (R23), which is a potent greenhouse gas. Using R23 as a cryogen for chilled mirrors in FPH instruments that fly on balloons up to 30 kilometers above the earth's surface is potentially harmful to the environment.

Accordingly, there is a need for FPHs with replacement cryogenic coolants that are less harmful to the environment and that are cold enough to use from the surface up to 30 km during a stratospheric balloon flight.

### SUMMARY OF THE INVENTION

Embodiments of the present invention provide a frost point hygrometer (FPH) apparatus capable of utilizing cryogenic coolant that are not harmful to the environment and that are sufficiently cold for use during a stratospheric balloon flight. FPH apparatus in accordance with some embodiments of the present invention includes a copper cold finger having a sink immersed in liquid cryogen to provide cooling power throughout the profile, a polished mirror disk residing at the opposite end of the cold finger with ambient air passing over the mirror, a nichrome heater wrapped around the narrow shaft of the continuous cold finger to provide heat to the mirror, an optical source and detector, such as an infrared light-emitting diode (LED) and a photodiode, to monitor the mirror's reflectivity as condensate accumulates in the form of dew or frost, a biconvex lens to focus the light reflected from the mirror into the photodiode, and a calibrated thermistor embedded in the mirror to measure the frost point temperature.

Accordingly, embodiments of the present invention relate to an apparatus for measuring moisture in air sample, the apparatus including a container for receiving a cryogen formed by a top wall, a bottom wall, a first side wall and a second side wall, wherein the top wall comprises a first opening to receive the cryogen into the container and a lid to seal the first opening, wherein the first side wall comprises a second opening positioned at a first proximal distance from the bottom wall; a thermal conductive rod extending into the container through the second opening of the container, wherein a first diameter of a distal portion of the thermal conductive rod is larger than a second diameter of a proximal portion the of thermal conductive rod, wherein the first diameter of the distal portion of the thermal conductive rod is substantially same as a third diameter of the second opening of the container to allow a snug fit at an interface between the distal portion of the thermal conductive rod and the second opening of the container, wherein the distal portion of the thermal conductive rod is in thermal contact with the cryogen received in the container; a cold plate thermally coupled to the distal portion of the thermal conductive rod, wherein the cold plate comprises a first curved surface to receive the distal portion of the thermal conductive rod, wherein the cold plate thermally dissipates heat from the distal portion of the thermal conductive rod; a reflective element thermally coupled to the proximal portion of the thermal conductive rod, wherein the reflecting element comprises a reflective surface positioned to receive the air sample at a predetermined flow rate; a heating element positioned on the proximal portion of the thermal conductive rod at a second proximal distance from the reflecting element, wherein the heating element is wrapped at least partially around the proximal portion of the thermal conductive rod, wherein the heating element selectively heats the reflective element; a temperature sensor positioned in thermal contact with the reflecting element, wherein the temperature sensor generates a first signal when the reflecting element reaches a frost point temperature; a mirror collar enclosing the proximal portion of the thermal conductive rod, the heating element and the temperature sensor; a light source positioned to illuminate the reflective surface of the reflecting element with a beam of light having a predetermined wavelength; a detector positioned to detect light reflected from the reflective surface of the reflecting element; an optics block for mounting the light source and detector, wherein the optics block is thermally coupled to the light source and the detector to maintain the light source and the detector at a predetermined temperature; a biconvex lens positioned to focus the light from the light source to illuminate the reflecting element and focus the light reflected by the reflective surface of the reflecting element to the detector; a first intake tube comprising a third opening to receive the air sample and fourth opening to deliver the air sample to flow across the reflective surface of the reflecting element; a second intake tube comprising a fifth opening to receive the air sample flowed across the reflective surface of the reflecting element and a sixth opening to discharge the air sample received via the fifth opening; a collar including: a seventh opening positioned to couple with the first intake tube and receive the air sample delivered from the fourth opening of the first intake tube; an eighth opening positioned to couple with the second intake tube and deliver the air sample flowed across the reflective surface of the reflecting element to the second intake tube; a ninth opening positioned to receive the reflecting element and the proximal portion of the thermal conductive rod enclosed by the mirror collar, wherein the receiving the proximal portion of the thermal conductive rod enclosed by the mirror collar and the reflecting element positions the reflecting element in a substantially center position inside the collar; a tenth opening to receive the biconvex lens and position the biconvex lens to focus the light from the light source to the reflective surface of the reflecting element and focus the light reflected by the reflective surface of the reflecting element to the detector; and a processor electrically coupled to the detector, wherein the processor receives electrical signals from the detector corresponding to the detected light reflected by the reflective surface of reflecting element, wherein the processor determines from the received electrical signals the moisture content in the air sample, wherein the processor is electrically coupled to the heating element, wherein the processor activates the heating element to heat the proximal portion of the thermal conductive rod to increase the temperature of the reflective surface of the reflecting element to reduce condensate formed on the reflective surface of the reflecting element.

Some embodiments of the present invention further includes a pressure relief valve positioned on the lid sealing the first opening, an insulating sleeve inserted into the second opening of the container to form an eleventh opening to receive the thermal conductive rod, wherein the insulating sleeve isolates the received thermal conductive rod from direct contact with the cryogen, wherein the top wall, the first side wall, the second side wall, and the insulating sleeve have a thickness of about 0.054 inches, and wherein the bottom wall has a thickness of about 0.075 inches, and wherein a diameter of the eleventh opening formed by the insulating sleeve is about 0.377 inches and wherein a depth of the eleventh opening formed by the insulating sleeve is about 0.275 inches.

In one embodiment of the present invention, the thermal conductive rod is fabricated using copper, the cold plate is fabricated using material selected from the group consisting of copper and aluminum, and the reflecting element is constructed using material selected from the group consisting of gold plated copper and rhodium plated copper.

In an exemplary embodiment of the present invention, the heating element is a nichrome heating coil.

In some embodiment of the present invention, the temperature sensor is selected from the group consisting of a thermistor, a platinum resistance thermometer, and a thermocouple.

In one embodiment of the present invention, the mirror collar is a thermoplastic sleeve.

In another embodiment of the present invention, the light source is a LED light source and the detector is a photodiode.

Some embodiment of the present invention further includes a lens heater thermally coupled to the biconvex lens, wherein the lens heater heats the biconvex lens to reduce the condensate formed on the biconvex lens.

In one embodiment of the present invention, the intake tube is a hydrophobic stainless steel inlet tubes having a diameter of about 2.25 cm.

In another embodiment of the present invention, the cryogen is a mixture of dry ice and alcohol.

Embodiments of the present invention also relate to an apparatus for measuring moisture in an air sample, the apparatus including: a container for receiving a cryogen formed by a top wall, a bottom wall, a first side wall and a second side wall, wherein the top wall comprises a first opening to receive the cryogen into the container and a lid to seal the first opening, wherein the first side wall comprises a second opening positioned at a first proximal distance from the bottom wall; a pressure relief valve positioned on the lid sealing the first opening; an insulating sleeve inserted into the second opening of the container to form a third opening to receive the thermal conductive rod, wherein the insulating sleeve isolates the received thermal conductive rod from direct contact with the cryogen; a thermal conductive rod extending into the container through the third opening of the container, wherein a first diameter of a distal portion of the thermal conductive rod is larger than a second diameter of a proximal portion the of thermal conductive rod, wherein the first diameter of the distal portion of the thermal conductive rod is substantially same as a third diameter of the third opening formed by the insulating sleeve to allow a snug fit at an interface between the distal portion of the thermal conductive rod and the third opening formed by the insulating sleeve; a cold plate thermally coupled to the distal portion of the thermal conductive rod, wherein the cold plate comprises a first curved surface to receive the distal portion of the thermal conductive rod, wherein the cold plate thermally dissipates heat from the distal portion of the thermal conductive rod; a reflective element thermally coupled to the proximal portion of the thermal conductive rod, wherein the reflecting element comprises a reflective surface positioned to receive the air sample at a predetermined flow rate; a heating element positioned on the proximal portion of the thermal conductive rod at a second proximal distance from to the reflecting element and wrapped at least partially around the proximal portion of the thermal conductive rod, wherein the heating element selectively heats the reflective element; a temperature sensor positioned in thermal contact with the reflective element, wherein the temperature sensor generates a first signal when the reflective element reaches a frost point temperature; a mirror collar enclosing the proximal portion of the thermal conductive rod, the heating element and the temperature sensor; a light source positioned to illuminate the reflective surface of the reflecting element with a beam of light having a predetermined wavelength; a detector positioned to detect light reflected from the reflective surface of the reflecting element; an optics block for mounting the light source and detector, wherein the optics block is thermally coupled to the light source and the detector to maintain the light source and the detector at a predetermined temperature; a biconvex lens positioned to focus the light from the light source to illuminate the reflecting element and focus the light reflected by the reflective surface of the reflecting element to the detector; a lens heater thermally coupled to the biconvex lens, wherein the lens heater heats the biconvex lens to reduce condensate formed on the biconvex lens; a first intake tube comprising a fourth opening to receive the air sample and a fifth opening to deliver the air sample to flow across the reflective surface of the reflecting element; a second intake tube comprising a sixth opening to receive the air sample flowed across the reflective surface of the reflecting element and a seventh opening to discharge the air sample received via the sixth opening; a collar comprising: an eighth opening positioned to couple with the first intake tube and receive the air sample delivered from the fifth opening of the first intake tube; a ninth opening positioned to couple with the second intake tube and receive the air sample flowed across the reflective surface of the reflecting element; a tenth opening positioned to receive the reflecting element and the proximal portion of the thermal conductive rod enclosed by the mirror collar, wherein the receiving the proximal portion of the thermal conductive rod enclosed by the mirror collar and the reflecting element positions the reflecting element in a substantially center position inside the collar; an eleventh opening to receive the biconvex lens and position the biconvex lens to focus the light from the light source to the reflective surface of the reflecting element and focus the light reflected by the reflective surface of the reflecting element to the detector; and a processor electrically coupled to the heating element and the detector, wherein the processor receives electrical signals from the detector corresponding to the detected light reflected by the reflective surface of reflecting element, wherein the processor determines from the received electrical signals the moisture content in the air sample. More particularly, the cryogen is liquid nitrogen.

In one embodiment of the present invention, the top wall, the first side wall, the second side wall, and the insulating sleeve have a thickness of about 0.054 inches, wherein the bottom wall has a thickness of about 0.075 inches, wherein a diameter of an opening formed by the insulating sleeve is about 0.377 inches, and wherein a depth of the third opening formed by the insulating sleeve is about 0.275 inches.

In another embodiment of the present invention, the thermal conductive rod is fabricated using copper, and the cold plate is fabricated using material selected from the group consisting of copper and aluminum.

### BRIEF DESCRIPTION OF DRAWINGS

FIG. 1 illustrates a FPH apparatus in accordance with embodiments of the present invention.

FIG. 2 illustrates a FPH apparatus in accordance with an alternate embodiment of the present invention.

FIG. 3 illustrates a cold finger of a FPH apparatus in accordance with an embodiment of the present invention.

FIG. 4 illustrates an alternate view of a cold finger of FPH apparatus in accordance with an embodiment of the present invention.

FIG. 5 illustrates an exemplary observation of mirror heat in FPH apparatus in accordance with an embodiment of the present invention and mirror heat in prior art FPH.

FIG. 6A, FIG. 6B and FIG. 6C illustrate exemplary observations of water vapor versus altitude using FPH apparatus in accordance with an embodiment of the present invention and water vapor versus altitude using prior art FPH during dual balloon flights at different times.

FIG. 7 illustrates exemplary observations of mirror reflectivity versus altitude during a use of FPH apparatus in accordance with an embodiment of the present invention.

### DETAILED DESCRIPTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention. Reference will now be made to the drawings wherein like numerals refer to like elements throughout.

FPH apparatus in accordance with embodiments of the present invention includes an in-situ balloon-borne chilled mirror hygrometer capable of measuring vertical profiles of frost point temperature up to about 28 km above earth's surface using chilled mirror principle, which relies on maintaining a thin, stable layer of condensate on a mirror disk through rapid feedback control.

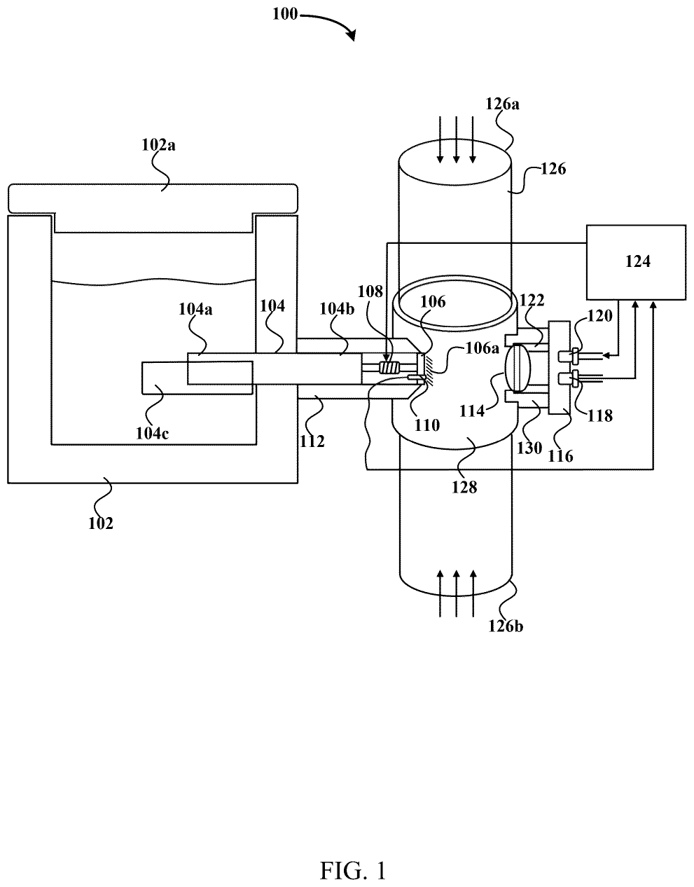

Referring now to the drawings, and more particularly, to FIG. 1, there is shown a FPH apparatus, generally designated 100, and schematically showing an embodiment of the present invention. FPH apparatus 100 includes a cryogen container 102, a thermal conductive rod 104, a reflecting element 106, a heating element 108, a temperature sensor 110, a mirror collar 112, a biconvex lens 114, an optics block 116, a detector 118, a light source 120, a lens heater 122, processor 124, a sample intake tube 126, a housing 128, and a lens collar 130.

Cryogen container 102 includes atop wall, a bottom wall and side walls forming an enclosure to define a space that is capable of holding a cryogen. Cryogen container 102 also includes a first opening positioned at top wall to receive cryogen from the exterior. In one embodiment of the present invention, a lid 102a is positioned on the first opening of cryogen container 102 to seal cryogen container 102. In some embodiments, cryogen container 102 walls are sufficiently insulated such that the temperature inside cryogen container 102 is maintained at or about cryogen temperature. In such embodiment, cryogen container 102 includes an inner wall which is in contact with the cryogen inside cryogen container 102 and an outer wall positioned to provide sufficient space between the inner and outer walls to mount an insulating thermal shield. In other embodiments, cryogen container 102 walls have sufficient thickness to maintain a predetermined pressure inside cryogen container 102. Exemplary material that can be used to form cryogen container 102 include extruded polystyrene foam, expanded polystyrene foam, high density polyethylene (HDPE), polytetrafluoroethylene (e.g., Teflon™), and the like. Cryogen container 102 further includes a second opening positioned along a side wall closer to the bottom of cryogen container 102 to receive thermal conductive rod 104. In one embodiment of the present invention, a mixture of dry ice and ethanol is used as cryogen to cool thermal conductive rod 104. In another embodiment of the present invention, liquid nitrogen is used as cryogen to cool thermal conductive rod 104.

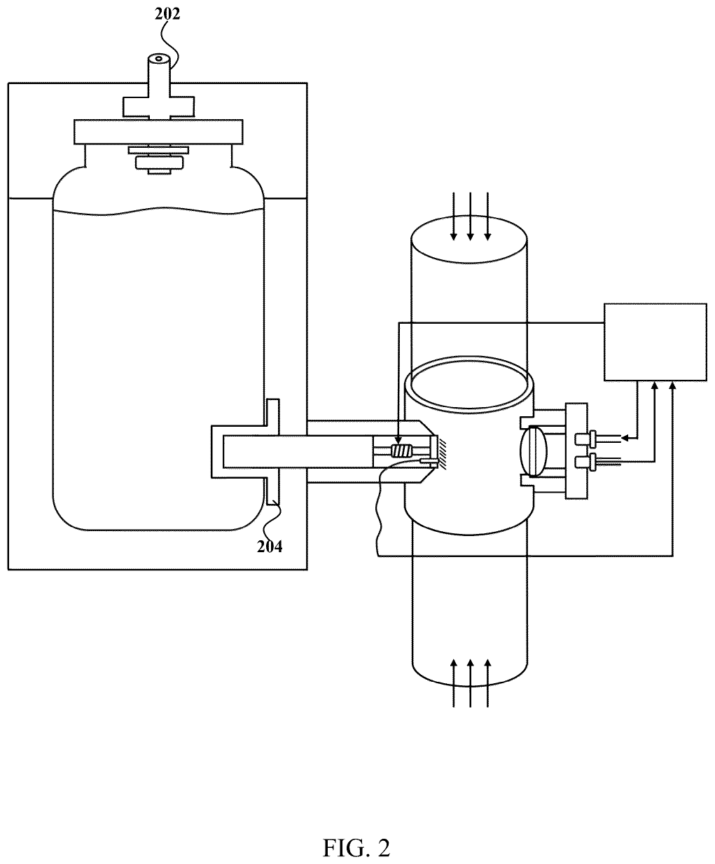

In embodiments of the present invention using liquid nitrogen as cryogen, cryogen container 102 walls are constructed using material capable of withstanding temperatures of about −210 deg C. and capable of withstanding pressures from about 1.82 psi to about 18 psi. Cryogen container 102 for holding liquid nitrogen includes a pressure relief valve 202 positioned on lid 102a sealing the first opening positioned at the top of cryogen container 102, as shown in FIG. 2. In one embodiment, pressure relief valve 202 is affixed to lid 102a using a washer and nut. Pressure relief valve 202 utilizes a spring that is capable of opening pressure relief valve 202 outward to create a path to vent nitrogen gas produced inside cryogen container 102 to the exterior when the pressure inside cryogen container 102 exceeds a threshold value. Cryogen container 102 is sealed to maintain the liquid nitrogen cryogen as liquid during the flight. In one embodiment of the present invention, pressure relief valve 202 is a 2.94 psi (202.7 hPa) valve. In another embodiment, cryogen container 102 is sealed to maintain a pressure of about 5 psi (344.7 hPa), which is below the triple point of liquid nitrogen at 125 hPa where it is freezes. Cryogen container 102 for holding liquid nitrogen further includes an insulating sleeve 204 affixed to the second opening of cryogen container 102, as shown in FIG. 2, to receive thermal conductive rod 104 inside insulating sleeve 204 and isolate thermal conductive rod 104 from direct contact with the liquid nitrogen cryogen. In one embodiment of the present invention, insulating sleeve 204 is affixed to cryogen container 102 using an adhesive. Insulating sleeve 204 further seals any gaps between thermal conductive rod 104 and side wall of cryogen container 102, as shown in FIG. 2. The dimensions of insulating sleeve 204 are such that it ensures air is not trapped between insulating sleeve 204 and cryogen container 102. Table 1 provides exemplary dimensions for insulating sleeve 204 shown in FIG. 2.

TABLE 1

| | Sleeve | Sleeve |
|---|---|---|
| | Insert | Insert |
| | 1 (inches) | 2 (inches) |
| Lip diameter | 0.750 | 0.875 |
| Lip thickness | 0.100 | 0.075 |
| Insert diameter | 0.485 | 0.484 |
| Cold finger insert length below 0.1″ lip | 0.825 | 0.275 |
| Insert internal diameter | 0.377 | 0.377 |
| Insert wall thickness | 0.0535 | 0.0535 |
| Bottom end wall thickness | 0.075 | 0.075 |
| Total length with lip thickness | 1.000 | 0.425 |

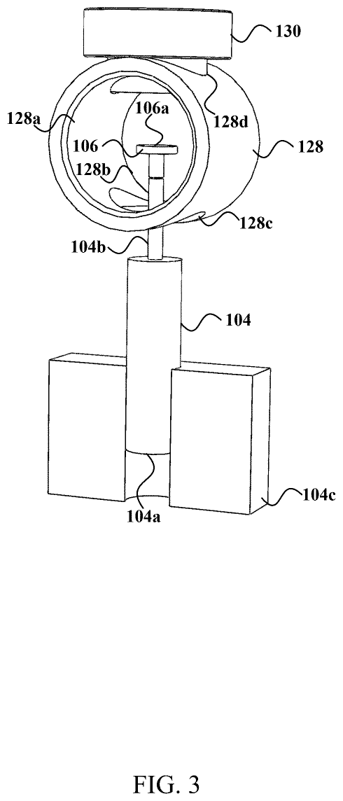

Referring back to FIG. 1, thermal conductive rod 104 includes cylindrical rod that extends into cryogen container 102 through the second opening of cryogen container 102 such that a distal portion 104a (“cold finger” region) of thermal conductive rod 104 is immersed in liquid cryogen contained in cryogen container 102 to provide cooling power for FPH apparatus 100. In one embodiment of the present invention, thermal conductive rod 104 is fabricated using copper. The diameter of distal portion 104a of thermal conductive rod 104 is larger than the diameter of proximal portion 104b (“neck” region) of thermal conductive rod 104, as shown in FIG. 3. The diameter of distal portion 104a of thermal conductive rod 104 is such that the second opening of cryogen container 102 fits snuggly around distal portion 104a of thermal conductive rod 104 in a manner that prevents the cryogen from leaking out of cryogen container 102 through the interface between the second opening of cryogen container 102 and distal portion 104a of thermal conductive rod 104. In some embodiments of the present invention, a sealant is used to seal the interface between the second opening of cryogen container 102 and distal portion 104a of thermal conductive rod 104. Exemplary sealants that can be used to seal the interface between the second opening of cryogen container 102 and distal portion 104a of thermal conductive rod 104 include a room temperature vulcanizing (RTV) sealant, and the like.

In embodiments of the present invention using dry ice and ethanol as cryogen, distal portion 104a of thermal conductive rod 104 is thermally coupled to a cold plate 104c, as further shown in FIG. 3, that thermally dissipates heat from distal portion 104a and lowers the temperature of distal portion 104a of thermal conductive rod 104. In one embodiment of the present invention, cold plate 104c is fabricated using copper. In another embodiment of the present invention, cold plate 104c is fabricated using aluminum. A surface of cold plate 104c may be milled to provide a curved surface to receive distal portion 104a of thermal conductive rod 104 and fix cold plate 104c to distal portion 104a of thermal conductive rod 104. Due to irregularities in the mating surfaces of cold plate 104c and distal portion 104a of thermal conductive rod 104, the two surfaces may not uniformly contact at all places thus forming air gaps in the interface. A layer of thermal glue, for example, may be applied between distal portion 104a of thermal conductive rod 104 and cold plate 104c at a thermal interface therebetween to increase heat flow, however other suitable materials including a phase change material are contemplated at this thermal interface and is not limited to thermal glue. The thermal glue provides a thermally uniform coupling between distal portion 104a of thermal conductive rod 104 and cold plate 104c. The thermal glue also fills the air gaps between the mating surfaces of distal portion 104a and cold plate 104c providing uniform thermal coupling between the two components. In some embodiments, the thermal interface is maintained by fixing distal portion 104a of thermal conductive rod 104 to cold plate 104c by mechanical means, such as screws or clamps (not shown).

Proximal portion 104b of thermal conductive rod 104 is thermally coupled to reflecting element 106, as shown in FIGS. 1-4. Reflecting element 106 is constructed to provide a uniform temperature across its surface. Exemplary material that can be used to construct reflecting element 106 includes copper, gold plated copper, rhodium plated copper, gold-palladium plated copper, and the like. In some embodiments of the present invention, thermal conductive rod 104 and reflecting element 106 are made from a single piece of copper. In such embodiments, the top surface of reflecting element 106 is lapped to a mirror finish and the entire piece is plated in gold to provide protection from corrosion and obtain a desired mirror finish. Reflecting element 106 is positioned to allow ambient air to pass over reflective surface 106a of reflecting element 106 at a predetermined flow rate. In embodiments wherein FPH apparatus 100 is mounted on a balloon, the flow rate is equal to the rise rate of the balloon as it goes up for the ascent profile and the descent rate for the descending profile. In one embodiment of the present invention, reflecting element 106 is positioned to allow ambient air to pass over reflective surface 106a of reflecting element 106 at a flow rate of from about 3 m/s to about 6 m/s.

Dimensions of reflecting element 106 can be determined by setting heat flow of distal portion 104a (“cold finger” region) of thermal conductive rod 104 equal to the heat flow of proximal portion 104b (“neck” region) of thermal conductive rod 104, as shown in Equations (1) and (2).

$$dQ / dt ( cold finger ) = dQ / dt ( neck )$$

$$dQ / dt = ( {k}_{cu} * A * ( {T}_{hot} - {T}_{cold} ) ) / L$$

wherein k is the material heat transfer coefficient (J/sec*m*deg C.), A is the heat transfer area (m²), T is the temperature (deg C.), and L is the length of the material.

Frost point temperature is achieved when a stable frost layer is present on reflective surface 106a of reflecting element 106, showing equilibrium between water vapor in the air sample and the condensate on the mirror. Due to the material and geometry, reflective surface 106a of reflecting element 106 is uniform in temperature across its diameter, and the water vapor partial pressure is calculated with respect to dew or ice depending on the phase of condensate on reflective surface 106a of reflecting element 106. The mixing ratio by volume is determined by dividing the water vapor partial pressure by the dry atmospheric pressure. Temperature sensor 110 may be calibrated against National Institute of Standards and Technology (NIST) traceable temperature standards when applying the chilled mirror principle. This eliminates water vapor calibration scales or standards which are difficult to create, maintain, and use in the field.

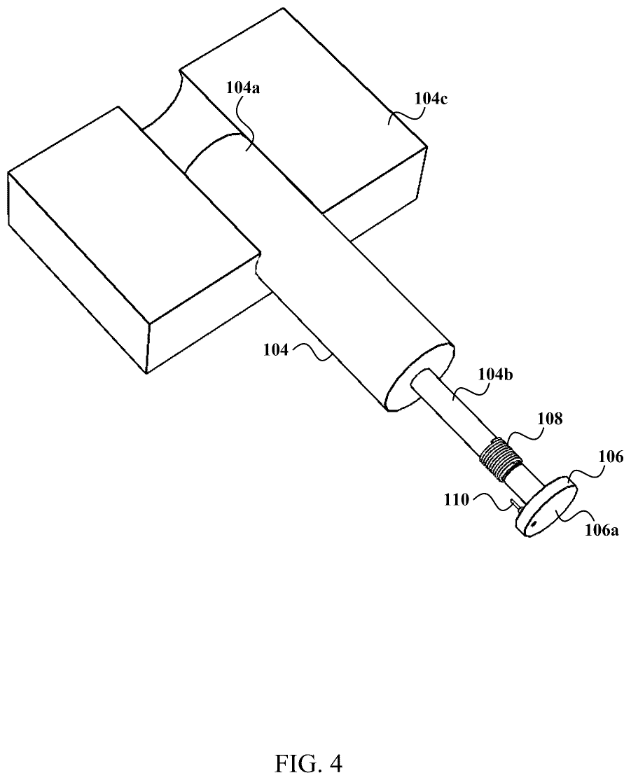

Heating element 108 is wrapped around proximal portion 104b of thermal conductive rod 104 at a position that is adjacent to reflecting element 106, as shown in FIG. 4, for actively heating thermal conductive rod 104 and connected reflecting element 106 to control the condensate thickness at a constant level. Heating element 108 is also used to reset reflective surface 106a of reflecting element 106 at predetermined temperatures or points during the balloon sounding in order to regrow known types of ice crystals on reflective surface 106a. In one embodiment of the present invention, heating element 108 is a nichrome heating coil.

The temperature of reflective surface 106a of reflecting element 106 is typically measured with temperature sensor 110 embedded in reflecting element 106. Temperature sensor 110 is positioned in thermal contact with reflecting element 106, as shown in FIG. 4, to provide an output signal when reflective surface 106a of reflecting element 106 reaches the dew or frost point temperature. In some embodiments of the present invention, temperature sensor 110 is positioned in thermal contact with reflecting element 106 using a thermal epoxy. In one embodiment of the present invention, temperature sensor 110 is a thermistor. In another embodiment of the present invention, temperature sensor 110 is a platinum resistance thermometer. In some embodiments of the present invention, temperature sensor 110 is a thermocouple.

Proximal portion 104b of thermal conductive rod 104, including heating element 108 and temperature sensor 110, is enclosed by mirror collar 112 such that reflecting element 106 is exposed to allow ambient air to pass over reflective surface 106a of reflecting element 106. In one embodiment of the present invention, mirror collar 112 is a thermoplastic sleeve.

Light source 120 is supported by optics block 116 and positioned to illuminate reflecting element 106, and detector 118 is supported by optics block 116 and positioned to detect light reflected from reflecting element 106. In one embodiment of the present invention, light source 120 is a LED light source and detector 118 is a photodiode. LED light source is operated as a blinking light source that is turned on and off at a frequency of about 24 Hz. Operating the LED light source as a blinking light source allows for subtracting stray light or sunlight measured when the LED is off from measurements when the LED is on. Optics block 116 is temperature stabilized to maintain light source 120 and detector 118 at a uniform temperature and to prevent light source 120 and detector 118 from drifting with temperature. In one embodiment, optics block 116 is made using aluminum that has been anodized black and temperature stabilized to 32 deg C. Optics block 116 is mechanically attached to lens collar 130 and thermally coupled to lens heater 122.

Biconvex lens 114 is mounted onto lens collar 130 and positioned to focus light from light source 120 to illuminate reflecting element 106. Biconvex lens 114 is also positioned to focus light reflected by reflective surface 106a of reflecting element 106 to detector 118. The reflected light received by detector 118 is used to monitor reflectivity of reflecting element 106 as condensate accumulates in the form of dew or frost. Lens heater 122 is optionally coupled to lens collar 130 and lens collar 130 is mechanically coupled to optics block 116. Heat from optics block 116 is transferred through lens heater 122 and onto biconvex lens 114 to reduce condensation that may form on biconvex lens 114. Opening 128d on the first side of housing 128 receives a portion of lens collar 130, as shown in FIGS. 1 and 3, such that biconvex lens 114 is positioned to focus light from light source 120 to illuminate reflecting element 106 and focus light reflected by reflecting element 106 to detector 118.

Intake tube 126 is positioned to deliver air sample across reflective surface 106a of reflecting element 106. Intake tube 126 includes a top intake tube 126a and a bottom intake tube 126b affixed to housing 128. Housing 128 includes a top opening 128a to receive top intake tube 126a and a bottom opening 128b to receive bottom intake tube 126b, as shown in FIGS. 1 and 3, such that longitudinal axis of top intake tube 126a, bottom intake tube 126b and housing 128 are aligned. Housing 128 also includes an opening 128c positioned on a second side in housing 128 to receive proximal portion 104b of thermal conductive rod 104 enclosed by mirror collar 112 such that reflecting element 106 is positioned substantially in the middle of housing 128, as shown in FIG. 3. Opening 128c on the second side of housing 128 is positioned opposite to opening 128d on the first side of housing 128. In one embodiment of the present invention, intake tube 126 is a hydrophobic stainless steel inlet tubes having a diameter of about 2.25 cm.

Processor 124 is electrically coupled to heating element 108 to activate heating element 108, which heats proximal portion 104b of thermal conductive rod 104 to increase the temperature of the surface of reflecting element 106 in a manner to reduce the condensate level. Processor 124 is also electrically coupled to detector 118 to receive electrical signals related to the light reflected by reflective surface 106a of reflecting element 106 indicating the condensate level. Processor 124 activates heating element 108 to increase the temperature of reflective surface 106a of reflecting element 106 in a manner to reduce the condensate level until processor 124 receives electrical signals from detector 118 indicating that the condensate level has returned to a predetermined level. In one embodiment of the present invention, processor 124 uses proportional, integral and derivative (PID) control to maintain a constant condensate level on reflective surface 106a of reflecting element 106. Processor 124 receives the temperature measured by temperature sensor 110, which processor 124 converts into water vapor mixing ratio using atmospheric pressure measured from a radiosonde pressure sensor. The radiosonde measures ambient conditions during a balloon flight such as temperature, pressure, and humidity.

During typical operation of FPH apparatus 100 in accordance with various embodiments of the present invention, FPH apparatus 100 is mounted on an airplane or a balloon and is flown as a disposable instrument package that can be reused if returned. Typical instrument package includes an ozonesonde, radiosonde and liquid cryogen, and is lightweight (<1.9 kg) and typically flown using a 1200 g latex balloon. FPH apparatus 100 in accordance with various embodiments of the present invention included with the instrument package can also be flown with a valve in the neck of the balloon, allowing slow, controlled descent profiles to be acquired. The instrument package is positioned at the bottom of the string unwinder that separates the balloon and parachute from the instrumentation to reduce water vapor contamination from balloon outgassing during the ascent. String unwinders can vary in length but are typically from about 35 meters to about 60 meters.

FPH apparatus 100 is first operated without cryogen on the ground prior to the flight. Light source 120 and detector 118 remain switched on and temperature sensor 110 is set to measure continuously. Temperature sensor 110 and reflective surface 106a of reflecting element 106 measure ambient air temp without a cryogen. Detector 118 measures a clean and clear reflective surface 106a. For example, a clear reflective surface 106a would have a value of about 970,000 counts on analog to digital converter (ADC) and a totally frosty mirror would have a value of about 0 ADC counts. An objective of FPH apparatus 100 is to obtain a constant layer of frost by controlled cooling of reflective surface 106a using the cryogen such that dew or ice forms on reflective surface 106a. Heating element 108 is used to heat reflecting element 106 from about 0% to about 100% to control the constant layer of frost using a PID gain schedule.

During typical flight operation of FPH apparatus 100, cryogen is added to container 102 allowing dew or frost to form on reflective surface 106a of reflective element 106. Distal portion 104a of thermal conductive rod 104 and cold plate 104c are brought into contact with cryogen to allow heat to dissipate from distal portion 104a of thermal conductive rod 104. The dissipation of heat from distal portion 104a of thermal conductive rod 104 cools proximal portion 104b of thermal conductive rod 104. Reflective surface 106a of reflecting element 106, which is in thermally conductive contact with proximal portion 104b of thermal conductive rod 104, is cooled to at least the dew or frost point temperature of the sample gas to be tested. The sample gas entering intake tube 126 is caused to flow over reflective surface 106a of reflecting element 106, which then condenses on reflective surface 106a of reflecting element 106. Light from light source 120 is directed onto reflective surface 106a of reflecting element 106 using biconvex lens 114, and the intensity of the light which is reflected from reflective surface 106a of reflecting element 106 is measured using detector 118. When cryogen is added to container 102, dew or ice begin to form on reflective surface 106a. An indication that the sample gas has reached its dew or frost point temperature is observed when moisture or frost has been collected on the reflective surface. The condensate on reflective surface 106a is monitored and actively controlled to maintain a stable, constant level of dew or ice by controlling the amount of heat delivered to heating element 108. Temperature sensor 110 is positioned in thermal contact with reflecting element 106 and constantly measures the temperature of reflecting element 106. The dew or frost point temperature is achieved only when a constant thickness of dew or ice is held constant on reflective surface 106a. Condensation of moisture or frost on reflective surface 106a of reflecting element 106 causes light from light source 120 to be scattered or absorbed. The intensity of the light reflected from reflective surface 106a of reflecting element 106 is reduced due to this scattering and absorption and then remains constant. Detector 118 detects the reduced amount of reflected light reaching detector 118 due to the scattering or absorption. Processor 124 determines whether the amount of dew or ice reaches a predetermined set point. In one embodiment, processor 124 determines whether there is about 21% scattered light and about 79% of the light reflected to detector 118. A PID controller with a dynamic gain schedule is used to turn heating element on or off to maintain a constant layer of dew or ice on reflective surface 106a.

Reflecting element 106 is reset, or a high level clear (HLC), when the temperature of reflecting element 106 reaches about −53 deg C. during flight, which typically occurs in the troposphere. A reset of reflective element 106 is performed by heating reflecting element 106 until detector 118 detects that the intensity of the light reflected from reflective surface 106a of reflecting element 106 is substantially same as the intensity of light from light source 120 incident on reflective surface 106a indicating a clean or clear reflective surface 106a. Heating element 108 is turned off when detector 118 detects a clean or clear mirror. Reset of reflecting element 106 is performed at about −53 deg C. to ensure hexagonal ice is formed back on reflective surface 106a of reflecting element 106.

Reference to the specific examples which follow and included herein are intended to provide a clearer understanding of systems and methods in accordance with embodiments of the present invention. The examples should not be construed as a limitation upon the scope of the present invention.

Simultaneous dual balloon flights were flown with FPH apparatus 100 to show agreement between R23 FPHs and alternative cryogens. FPH apparatus 100 in accordance with an embodiment of the present invention, using dry ice and ethanol mixture as cryogen, was mounted on a 1200 g latex balloon (DIA FPH), and flown to a height of about 28 km simultaneously with a prior art FPH, using R23 as cryogen, mounted on another 1200 g latex balloon (R23 FPH).

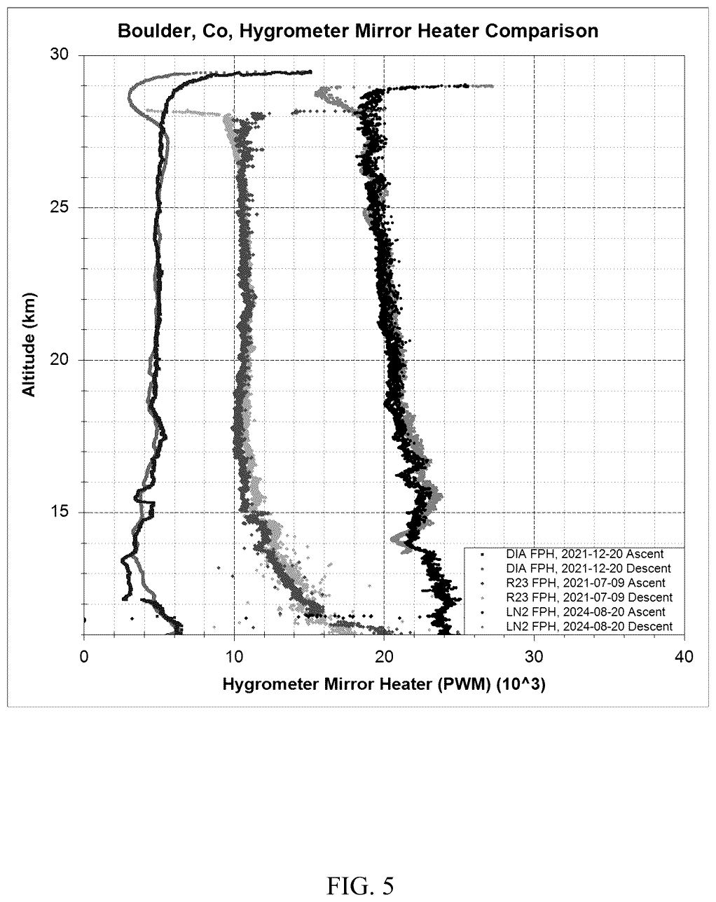

FIG. 5 illustrates exemplary observations of mirror heat in FPH apparatus 100 and mirror heat in prior art FPH during the balloon flights. Dimensions and characteristics of FPH apparatus 100 used during this flight are provided in Table 2.

TABLE 2

| Heat Flow | 1181 | W |
|---|---|---|
| T_{junc} | −100.2° | C. |
| Cryogen | 200 ml Alcohol, 190 ml DI | |
| | (DI crushed from blocks) | |
| Cu cold sink | 0.95 × 1.5 × 0.375″ | |
| 19 km PWM | 2.2 | W |
| CF dia, len | 0.375″, 1.315″ | |
| Neck dia, len, | 0.1″, 0.725″ | |
| Dewar | 392 cc (reg FPH dewar, flat lid) | |
| HLC min T | −81.3° | C. |
| HLC max T | −15.1° | C. |

| | |
|---|---|
| Heat Rate | 7.6° C./sec, 15.2% low |
| Cooling Rate | −12° C./sec, 10.9% high |

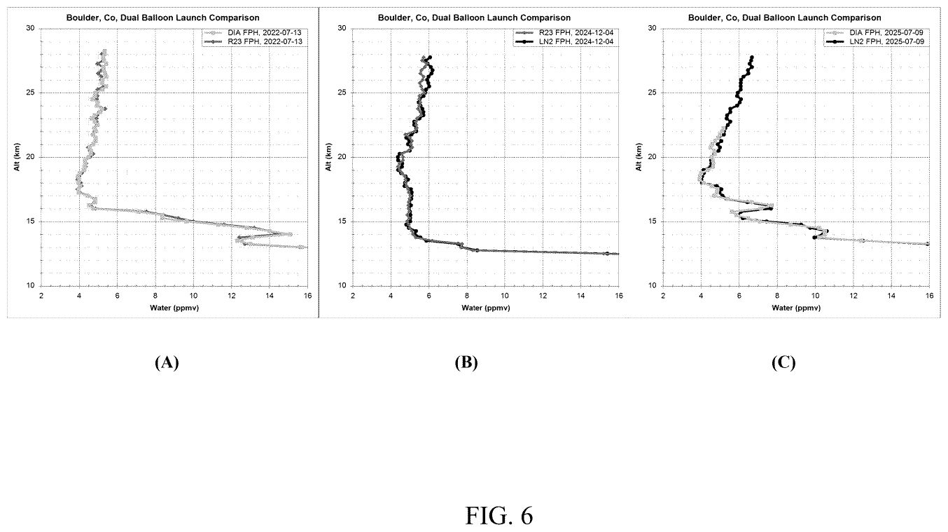

FIG. 6 illustrates exemplary observations of water vapor in FPH apparatus 100 and water vapor in the prior art FPH during dual balloon flights at the same times. FIG. 6A illustrates exemplary observations between FPH apparatus 100 using dry ice and ethanol as the cryogen and water vapor in prior art FPH during a balloon flight in July of 2021 over Boulder, Co. FIG. 6B provides exemplary water vapor observations showing FPH apparatus 100 using liquid nitrogen as the cryogen and water vapor in prior art FPH during a dual balloon flight in December 2024 over Boulder, Co. Similarly, FIG. 6C illustrates exemplary observations of water vapor in FPH apparatus 100 between FPH apparatus 100 using liquid nitrogen and FPH apparatus 100 using dry ice and ethanol. These comparison profiles show an agreement in the stratosphere between all three different types of cryogens used in FPH apparatus 100.

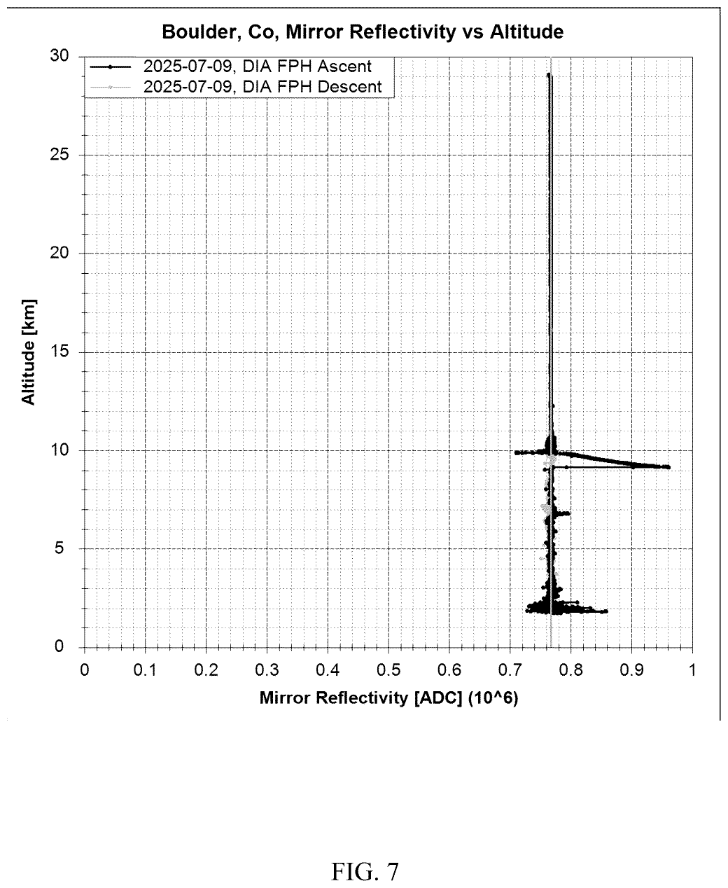

FIG. 7 illustrates a plot showing the reflectivity of reflective surface 106a versus altitude during a flight. FIG. 7 shows that processor 124 controls the reflectivity of reflective surface 106a such that the reflectivity is at a set point of about 767,238 ADC counts during the flight. A deviation is observed at the high level clear (HLC), which occurs at 9 km when processor 124 turns on heating element 108 to heat reflecting element 106 to burn off the frost layer. Processor 124 turns off heating element 108 when detector 118 detects a clean or clear mirror, and hexagonal ice reform at about 10 km. The set point is the gray line vertically at 767,238 ADC counts. The ascent is black and the descent is light gray. Some noise is observed in the troposphere where the water vapor in the atmosphere changes rapidly making it harder to maintain reflectivity of reflective surface 106a at the set point.

FPH apparatus in accordance with embodiments of the present invention has several advantages over previous FPH apparatus. FPH apparatus in accordance with embodiments of the present invention allows for the use of a cryogen that is non-toxic, having low Global Warming Potential (GWP) and Ozone Depleting Potential (ODP), provides cooling for long FPH valved balloon profiles (3.5-4 hours), easily accessible and inexpensive, and provides sufficient cooling at the tropopause and stratosphere (ΔT). In particular, FPH apparatus in accordance with various embodiments of the present invention enables the use of dry ice and alcohol as cryogen, which is a safer alternative to R23. Dry ice and alcohol mixture is harder to use as a cryogen because the mixture is warmer than R23 throughout the profile, have smallest ΔT located near the tropopause, in turn, making it harder to use for tropical water vapor balloon profiles with smaller ΔT˜12 deg C. The ΔT between the frost point temperature and the cryogen temperature needs to be sufficiently large to allow frost to form on the mirror. If ΔT is too small, then it will become difficult to sufficiently grow and control the frost on the reflective surface of the FPH. The use of dry ice and ethanol as cryogen and the inclusion of copper cold sink piece to the cold finger causes ΔT between the frost point temperature and the cryogen temperature needs to be sufficiently large to allow frost to form on the mirror. FPH apparatus in accordance with various embodiments of the present invention enables the use of liquid nitrogen as cryogen, which is also a safer alternative to R23. LN2 is much colder and causes a large ΔT between the frost point temperature and the cryogen temperature, which is minimized by insulating insert surrounding cold finger of FPH apparatus in accordance with various embodiments of the present invention.

FPH apparatus in accordance with embodiments of the present invention can be adapted to a variety of configurations. It is thought that FPH apparatus in accordance with various embodiments of the present invention and many of its attendant advantages will be understood from the foregoing description and it will be apparent that various changes may be made without departing from the spirit and scope of the invention or sacrificing all of its material advantages, the form hereinbefore described being merely a preferred or exemplary embodiment thereof.

Those familiar with the art will understand that embodiments of the invention may be employed, for various specific purposes, without departing from the essential substance thereof. The description of any one embodiment given above is intended to illustrate an example rather than to limit the invention. This above description is not intended to indicate that any one embodiment is necessarily preferred over any other one for all purposes, or to limit the scope of the invention by describing any such embodiment, which invention scope is intended to be determined by the claims, properly construed, including all subject matter encompassed by the doctrine of equivalents as properly applied to the claims.

What is claimed is:

1. An apparatus for measuring moisture in air sample, said apparatus comprising:
a container for receiving a cryogen formed by a top wall, a bottom wall, a first side wall and a second side wall, wherein the top wall comprises a first opening to receive the cryogen into the container and a lid to seal the first opening, wherein the first side wall comprises a second opening positioned at a first proximal distance from the bottom wall;
a thermal conductive rod extending into the container through the second opening of the container, wherein a first diameter of a distal portion of the thermal conductive rod is larger than a second diameter of a proximal portion the of thermal conductive rod, wherein the first diameter of the distal portion of the thermal conductive rod is substantially same as a third diameter of the second opening of the container to allow a snug fit at an interface between the distal portion of the thermal conductive rod and the second opening of the container, wherein the distal portion of the thermal conductive rod is in thermal contact with the cryogen received in the container;
a cold plate thermally coupled to the distal portion of the thermal conductive rod, wherein the cold plate comprises a first curved surface to receive the distal portion of the thermal conductive rod, wherein the cold plate thermally dissipates heat from the distal portion of the thermal conductive rod;
a reflective element thermally coupled to the proximal portion of the thermal conductive rod, wherein the reflecting element comprises a reflective surface positioned to receive the air sample at a predetermined flow rate;
a heating element positioned on the proximal portion of the thermal conductive rod at a second proximal distance from the reflecting element, wherein the heating element is wrapped at least partially around the proximal portion of the thermal conductive rod, wherein the heating element selectively heats the reflective element;
a temperature sensor positioned in thermal contact with the reflecting element, wherein the temperature sensor generates a first signal when the reflecting element reaches a frost point temperature;
a mirror collar enclosing the proximal portion of the thermal conductive rod, the heating element and the temperature sensor;
a light source positioned to illuminate the reflective surface of the reflecting element with a beam of light having a predetermined wavelength;
a detector positioned to detect light reflected from the reflective surface of the reflecting element;
an optics block for mounting the light source and detector, wherein the optics block is thermally coupled to the light source and the detector to maintain the light source and the detector at a predetermined temperature;
a biconvex lens positioned to focus the light from the light source to illuminate the reflecting element and focus the light reflected by the reflective surface of the reflecting element to the detector;
a first intake tube comprising a third opening to receive the air sample and fourth opening to deliver the air sample to flow across the reflective surface of the reflecting element;
a second intake tube comprising a fifth opening to receive the air sample flowed across the reflective surface of the reflecting element and a sixth opening to discharge the air sample received via the fifth opening;
a collar comprising:
a seventh opening positioned to couple with the first intake tube and receive the air sample delivered from the fourth opening of the first intake tube;
an eighth opening positioned to couple with the second intake tube and deliver the air sample flowed across the reflective surface of the reflecting element to the second intake tube;
a ninth opening positioned to receive the reflecting element and the proximal portion of the thermal conductive rod enclosed by the mirror collar, wherein the receiving the proximal portion of the thermal conductive rod enclosed by the mirror collar and the reflecting element positions the reflecting element in a substantially center position inside the collar;
a tenth opening to receive the biconvex lens and position the biconvex lens to focus the light from the light source to the reflective surface of the reflecting element and focus the light reflected by the reflective surface of the reflecting element to the detector; and
a processor electrically coupled to the detector, wherein the processor receives electrical signals from the detector corresponding to the detected light reflected by the reflective surface of reflecting element, wherein the processor determines from the received electrical signals the moisture content in the air sample, wherein the processor is electrically coupled to the heating element, wherein the processor activates the heating element to heat the proximal portion of the thermal conductive rod to increase the temperature of the reflective surface of the reflecting element to reduce condensate formed on the reflective surface of the reflecting element.

2. The apparatus of claim 1, further comprising a pressure relief valve positioned on the lid sealing the first opening.

3. The apparatus of claim 2, further comprising an insulating sleeve inserted into the second opening of the container to form an eleventh opening to receive the thermal conductive rod, wherein the insulating sleeve isolates the received thermal conductive rod from direct contact with the cryogen.

4. The apparatus of claim 3, wherein the top wall, the first side wall, the second side wall, and the insulating sleeve have a thickness of about 0.054 inches, and wherein the bottom wall has a thickness of about 0.075 inches.

5. The apparatus of claim 3, wherein a diameter of the eleventh opening formed by the insulating sleeve is about 0.377 inches and wherein a depth of the eleventh opening formed by the insulating sleeve is about 0.275 inches.

6. The apparatus of claim 1, wherein the thermal conductive rod is fabricated using copper.

7. The apparatus of claim 1, wherein the cold plate is fabricated using material selected from the group consisting of copper and aluminum.

8. The apparatus of claim 1, wherein the reflecting element is constructed using material selected from the group consisting of gold plated copper and rhodium plated copper.

9. The apparatus of claim 1, wherein the heating element is a nichrome heating coil.

10. The apparatus of claim 1, wherein the temperature sensor is selected from the group consisting of a thermistor, a platinum resistance thermometer, and a thermocouple.

11. The apparatus of claim 1, wherein the mirror collar is a thermoplastic sleeve.

12. The apparatus of claim 1, wherein the light source is a LED light source and the detector is a photodiode.

13. The apparatus of claim 1, further comprising a lens heater thermally coupled to the biconvex lens, wherein the lens heater heats the biconvex lens to reduce the condensate formed on the biconvex lens.

14. The apparatus of claim 1, wherein the intake tube is a hydrophobic stainless steel inlet tubes having a diameter of about 2.25 cm.

15. The apparatus of claim 1, wherein the cryogen is a mixture of dry ice and alcohol.

16. An apparatus for measuring moisture in an air sample, said apparatus comprising:
a container for receiving a cryogen formed by a top wall, a bottom wall, a first side wall and a second side wall, wherein the top wall comprises a first opening to receive the cryogen into the container and a lid to seal the first opening, wherein the first side wall comprises a second opening positioned at a first proximal distance from the bottom wall;
a pressure relief valve positioned on the lid sealing the first opening;
an insulating sleeve inserted into the second opening of the container to form a third opening to receive the thermal conductive rod, wherein the insulating sleeve isolates the received thermal conductive rod from direct contact with the cryogen;
a thermal conductive rod extending into the container through the third opening of the container, wherein a first diameter of a distal portion of the thermal conductive rod is larger than a second diameter of a proximal portion the of thermal conductive rod, wherein the first diameter of the distal portion of the thermal conductive rod is substantially same as a third diameter of the third opening formed by the insulating sleeve to allow a snug fit at an interface between the distal portion of the thermal conductive rod and the third opening formed by the insulating sleeve;
a cold plate thermally coupled to the distal portion of the thermal conductive rod, wherein the cold plate comprises a first curved surface to receive the distal portion of the thermal conductive rod, wherein the cold plate thermally dissipates heat from the distal portion of the thermal conductive rod;
a reflective element thermally coupled to the proximal portion of the thermal conductive rod, wherein the reflecting element comprises a reflective surface positioned to receive the air sample at a predetermined flow rate;
a heating element positioned on the proximal portion of the thermal conductive rod at a second proximal distance from to the reflecting element and wrapped at least partially around the proximal portion of the thermal conductive rod, wherein the heating element selectively heats the reflective element;
a temperature sensor positioned in thermal contact with the reflective element, wherein the temperature sensor generates a first signal when the reflective element reaches a frost point temperature;
a mirror collar enclosing the proximal portion of the thermal conductive rod, the heating element and the temperature sensor;
a light source positioned to illuminate the reflective surface of the reflecting element with a beam of light having a predetermined wavelength;
a detector positioned to detect light reflected from the reflective surface of the reflecting element;
an optics block for mounting the light source and detector, wherein the optics block is thermally coupled to the light source and the detector to maintain the light source and the detector at a predetermined temperature;
a biconvex lens positioned to focus the light from the light source to illuminate the reflecting element and focus the light reflected by the reflective surface of the reflecting element to the detector;
a lens heater thermally coupled to the biconvex lens, wherein the lens heater heats the biconvex lens to reduce condensate formed on the biconvex lens;
a first intake tube comprising a fourth opening to receive the air sample and a fifth opening to deliver the air sample to flow across the reflective surface of the reflecting element;
a second intake tube comprising a sixth opening to receive the air sample flowed across the reflective surface of the reflecting element and a seventh opening to discharge the air sample received via the sixth opening;
a collar comprising:
an eighth opening positioned to couple with the first intake tube and receive the air sample delivered from the fifth opening of the first intake tube;
a ninth opening positioned to couple with the second intake tube and receive the air sample flowed across the reflective surface of the reflecting element;
a tenth opening positioned to receive the reflecting element and the proximal portion of the thermal conductive rod enclosed by the mirror collar, wherein the receiving the proximal portion of the thermal conductive rod enclosed by the mirror collar and the reflecting element positions the reflecting element in a substantially center position inside the collar;
an eleventh opening to receive the biconvex lens and position the biconvex lens to focus the light from the light source to the reflective surface of the reflecting element and focus the light reflected by the reflective surface of the reflecting element to the detector; and
a processor electrically coupled to the heating element and the detector, wherein the processor receives electrical signals from the detector corresponding to the detected light reflected by the reflective surface of reflecting element, wherein the processor determines from the received electrical signals the moisture content in the air sample.

17. The apparatus of claim 16, wherein the cryogen is liquid nitrogen.

18. The apparatus of claim 16, wherein the top wall, the first side wall, the second side wall, and the insulating sleeve have a thickness of about 0.054 inches, wherein the bottom wall has a thickness of about 0.075 inches, wherein a diameter of an opening formed by the insulating sleeve is about 0.377 inches, and wherein a depth of the third opening formed by the insulating sleeve is about 0.275 inches.

19. The apparatus of claim 16, wherein the thermal conductive rod is fabricated using copper.

20. The apparatus of claim 16, wherein the cold plate is fabricated using material selected from the group consisting of copper and aluminum.
